(19) United States
(12) Patent Application Publication
(10) Pub. No.: US 2015/0156963 A1
(43) Pub. Date: Jun. 11, 2015

(54) Apparatus for Laying Seed Film and Method for Laying Seed Film by Using the Apparatus for Laying the Seed Film

(71) Applicant: Ock KWON, (US)

(72) Inventor: Young Hoon Choe, Chungcheongbuk-do (KR)

(73) Assignee: Ock Kwon, Gyeonggi-do (KR)

(21) Appl. No.: 14/401,218

(22) PCT Filed: Jan. 21, 2013
(86) PCT No.: PCT/KR2013/000450

§ 371 Date: Nov. 14, 2014

(30) Foreign Application Priority Data
May 8, 2012 (KR) 10-2012-0053262

(51) Int. Cl. A01C 7/04; A01C 14/00; A01B 79/02; A01B 49/06; A01B 63/00

(52) U.S. Cl. CPC A01C 7/048; A01B 49/06; A01B 63/008; A01B 79/02; A01C 14/00

(57) ABSTRACT

The present invention relates to an apparatus for laying a seed film (hereinafter, seed film refers to a mulching film to which seeds are adhered and coating same for use in sowing) and a method for laying the seed film by using same. More specifically, the present invention relates to the apparatus for laying the seed film and the method for laying the seed film by using the apparatus for laying the seed film, the apparatus comprising: a leveling board of which the angle can be adjusted; a seed film pressing portion for pressing the seed film which is unrolled; and a seed film fixing portion for fixing the seed film, thereby automatically laying the seed film on a rice paddy in a quick and convenient manner.

### CROSS-REFERENCE TO RELATED APPLICATIONS

This is a US national phase of PCT patent Application No. PCT/KR2013/000450 having an International filing date of Jan. 21, 2013, which claims priority to Korean Patent Application No. 10-2012-0053262, filed on May 18, 2012, the entireties of which are incorporated herein by reference.

### FIELD OF THE INVENTION

The present invention relates to an apparatus for laying a seed film (hereinafter, the seed film refers to a state where seeds are adhered to a seed film for the use when sowing at a time a lot of seeds after adhering seeds to a mulching film and coating the same) and a method for laying the seed film by using same. More specifically, the present invention relates to an apparatus for laying a seed film and a method for laying a seed film by using the apparatus for laying the seed film, wherein the apparatus includes a leveling board of which the angle can be adjusted, a seed film pressing unit for pressing the seed film which is being unrolled, and a seed film fixing unit for fixing in place the seed film, thereby automatically laying the seed film over the soil of a rice paddy in a quick and convenient manner.

### BACKGROUND OF THE INVENTION

In general, a mulching film is laid before seeds are sowed so as to remove the growth of weed and to keep heat and moisture. In consideration of the current situations in rural farming regions where are in lack of labor, it was expected to save a lot of labor if work for laying a mulching film and sowing seeds could be performed together. Thereafter, the use of a seed film made by attaching seeds to a mulching film progressively increases. For this reason, the necessity for the apparatus for laying a seed film also increases.

Such a seed film may be used for both the field crop and the rice paddy crop. The Korean Patent Registration Number 1015966 describes a method for cultivating rice using a method for laying a seed film, and as illustrated in FIG. 13, the Korean Patent Registration Number 1015966 describes a laying apparatus which includes a seed film holding unit, and a seed film pressing unit.

The above-mentioned conventional laying apparatus however may not well withstand any changes in the height and hardness of soil, and there has been a problem when the laying apparatus is actually applied to the sites of rural farming regions because the seed film could not be uniformly pressed and fixed in place. For this reason, there has been a demand on an apparatus and method for laying a seed film by which it is possible to uniformly flatten the soil of farmland before the seed film is laid, and both sides of the seed film can be fixed while continuously pressing the seed film which has been spread over the soil of the farmland, and the seed film can be automatically cut.

### BRIEF DESCRIPTION OF DRAWINGS

FIG. 1 is a perspective view when viewing, from the rear side, an apparatus for laying a seed film according to an exemplary embodiment of the present invention.

FIG. 2 is a plane view illustrating a seed film according to an exemplary embodiment of the present invention.

FIG. 3 is a flow chart of a method for laying a seed film according to an exemplary embodiment of the present invention.

FIG. 4 is a side view illustrating a leveling board and an adjusting unit of an apparatus for laying a seed film according to an exemplary embodiment of the present invention.

FIG. 5 is a perspective view when viewing, from the front side, a leveling board of an apparatus for laying a seed film according to an exemplary embodiment of the present invention.

FIG. 6 is a perspective view when viewing, from the rear side, a leveling board of an apparatus for laying a seed film according to an exemplary embodiment of the present invention.

FIG. 7 is a partial side view illustrating a state where a cutter unit of a seed film fixing unit of an apparatus for laying a seed film is operated according to an exemplary embodiment of the present invention.

### DETAILED DESCRIPTION OF THE INVENTION

The present invention is made in an effort to improve the above mentioned problems. It is an object of the present invention to provide an apparatus for laying a seed film and a method for laying a rice seed in a way of dibbling and bio-distribution using the apparatus for laying the seed film wherein the apparatus includes a leveling board of which the angle can be adjusted, a seed film pressing unit for pressing the seed film which is being unrolled, and a seed film fixing unit for fixing in place the seed film, thereby automatically laying the seed film over the soil of a rice paddy in a quick and convenient manner.

In addition, there are provided an apparatus for laying a seed film and a method for laying a rice seed in a way of dibbling and bio-distribution using the apparatus for laying the seed film wherein the above-mentioned laying apparatus is configured to be detachably attached to all kinds of agriculture machines such as a rice transplanter, a tractor, a cultivator, a farm master, etc. and includes a leveling board adjusting unit for thereby evenly flattening the soil of a rice paddy in response to any changes in the height and hardness of the soil of the rice paddy, and the seed film may be continuously pressed and fixed.

In addition, there are provided an apparatus for laying a seed film and a method for laying a rice seed in a way of dibbling and bio-distribution using the apparatus for laying the seed film wherein the seed film fixing unit includes an absorber unit for thereby preventing impacts due to any change in the height and hardness of the soil of the rice paddy while adjusting the depth where the seed film fixing unit is buried under the soil, and there is provided a cutter unit configured to automatically cut the seed film by driving a cutter operation unit when a laying work is finished.

Other objects, specific advantages and new features of the present invention will become apparent along with the following descriptions and exemplary embodiments in relation with the accompanying drawings.

### Technical Solution

To achieve the above objects, there is provided an apparatus for laying a seed film which is installed at a rear side of an agriculture machine such as a ride mulcher, a rice transplanter, a tractor, a cultivator, a farm master, etc., comprising a frame which is provided at a rear side of the agriculture machine; a seed film holding unit around which a seed film is wound and which is installed at the top of the frame; a leveling board which is provided at the bottom of the frame and the longitudinal direction of which is in parallel with the direction of the plane of the soil of the rice paddy, wherein the leveling board is configured to evenly flatten the soil of the rice paddy where the seed film has been laid; a seed film pressing unit which is separated by a predetermined distance from the leveling board and is provided at a rear side of the leveling board for thereby pressing the seed film, which has been spread over the soil of the rice paddy, by the rotation of the seed film holding unit; and a wheel-shaped seed film fixing unit which is provided at a rear side of the seed film pressing unit and is configured to fixedly press the ends of both sides of the pressed seed film.

The leveling board is concavely curved toward the rear side and includes an adjusting means configured to rotate the leveling board about the axis of the longitudinal direction of the leveling board, a sensor configured to detect the height and hardness of the soil of the rice paddy, and a controller configured to control the adjusting means based on the data detected by the sensor.

The present invention is characterized in that there is further provided an elastic member which is connected to one side of the center of the top of the frame and the side surfaces of both sides of the leveling board, respectively, for thereby maintaining left and right balances of the leveling board.

The present invention is characterized in that there are further provided a holding unit support configured to connect both sides of the top of the frame and ends of both sides of the seed film holding unit, respectively; a pressing unit support configured to connect both sides of the bottom of the frame and ends of both sides of the seed film pressing unit, respectively; and a fixing unit support configured to connect both sides of the bottom of the frame and ends of both sides of the seed film fixing unit, respectively.

The present invention is characterized in that there are further provided a fixing shaft configured to fix the seed film fixing unit provided at each of the ends of the fixing unit support; and at least one pressing wheel which is disposed at the fixing shaft and is configured to press the seed film and has a diameter smaller than the diameter of the seed film fixing unit.

The present invention is characterized in that the seed film fixing unit further includes an absorber unit configured to adjust the depth where the seed film fixing unit is planted into the soil of the rice paddy and absorb impacts.

The present invention is characterized in that there is further provided a cutter unit which is provided at an end portion of the fixing unit support for thereby cutting the laid seed film.

As another category of the present invention, to achieve the above object, there is provided a method for laying a seed film using the apparatus for laying a seed film which has been mentioned earlier, comprising a step where the soil of a rice paddy is evenly flattened by a leveling board installed at a rear side of an agriculture machine while the agriculture machine moves forward by the operation of the agriculture machine; a step where a seed film wound around the seed film holding unit by the rotation of the seed film holding unit is laid in front of the seed film pressing unit, and the laid seed film is pressed against the soil of the rice paddy by means of the seed film pressing unit; and a step where the seed film is fixed on the soil of the rice paddy while the seed film fixing unit presses both sides of the pressed seed film.

### Advantageous Effects

The exemplary embodiment of the present invention has an effect in the way that there are provided a leveling board of which the angle can be adjusted, a seed film pressing unit for pressing the seed film which is being unrolled, and a seed film fixing unit for fixing in place the seed film, thereby automatically laying the seed film on a rice paddy in a quick and convenient manner.

In addition, the present invention has an effect in the way that the laying apparatus may be detachably attached to all kinds of agriculture machines such as a rice transplanter, a tractor, a cultivator, a farm master, etc. and includes a leveling board adjusting unit for thereby evenly flattening the soil of a rice paddy in response to any changes in the height and hardness of the soil of the rice paddy, and the seed film may be continuously pressed and fixed.

In addition, the present invention has an effect in the way that the seed film fixing unit includes an absorber unit for thereby preventing impacts due to any change in the height and hardness of the soil of the rice paddy while adjusting the depth where the seed film fixing unit is buried under the soil, and there is provided a cutter unit configured to automatically cut the seed film by driving a cutter operation unit when a laying work is finished.

Although the present invention has been described in relation with the above-mentioned exemplary embodiments, it is obvious that a person having ordinary skill in the art may variously modify and amend without departing from the concept and scope of the present invention, and such modification and amendments may belong to the scope of the attached claims.

### MODE FOR INVENTION

The exemplary embodiments of the present invention which a person having ordinary skill in the art can easily implement will be described with reference to the accompanying drawings, provided that if it is judged that the detailed description on the related function or configuration may make unclear the concept of the invention while describing in detail the operational principle with respect to the exemplary embodiment of the present invention, the description thereof might be omitted.

In addition, the components having the similar functions and operations might be given the same reference numbers over the specification. In the course of the descriptions of the specification, what a predetermined component is described as being connected to any component means that the predetermined component may be directly connected thereto or it may be indirectly connected thereto through another predetermined component disposed between them. In addition, what a predetermined component is included means that unless otherwise stated means that another component may be further included not excluding any other component.

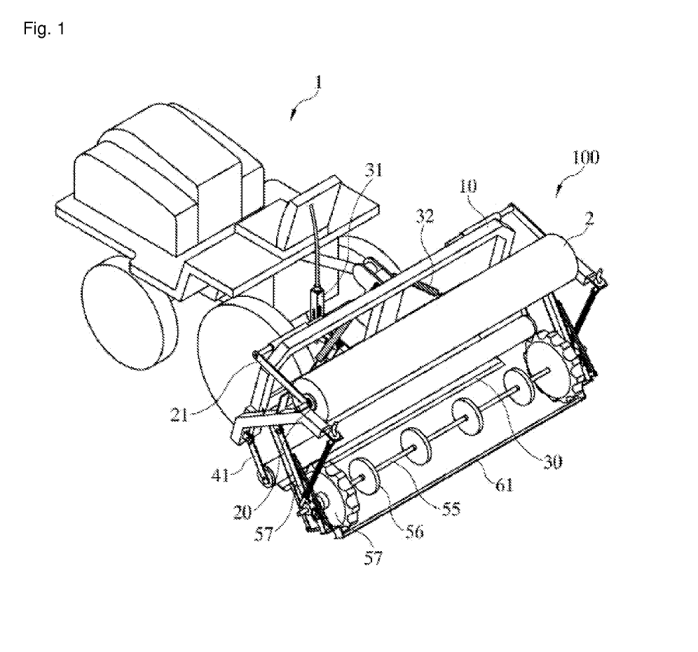

The configuration and operation of the seed film laying apparatus 100 according to an exemplary embodiment of the present invention will be first described herein below, and then the method for laying a rice seed in a way of dibbling and bio-distribution using the seed film laying apparatus 100 will be described. First, FIG. 1 is a perspective view when viewing, from the rear side, an apparatus for laying a seed film according to an exemplary embodiment of the present invention.

As illustrated in FIG. 1, the seed film laying apparatus 100 according to an exemplary embodiment of the present invention is characterized in that an agricultural machine such as a ride mulcher, a rice transplanter, a tractor, a cultivator, a farm master, etc. is detachably attached to the rear side of the seed film laying apparatus 100.

The seed film laying apparatus 100 according to an exemplary embodiment of the present invention, as illustrated in FIG. 1, includes a frame 100 installed at the rear side of the agricultural machine 1, a seed film holding unit 20 which is secured to the top of the frame 10 wherein a seed film 2 is wound around the seed film holding unit 20, a leveling board 30 which is secured to the bottom of the frame 10 for evenly flattening the soil of the rice paddy where the seed film 2 is laid, a seed film pressing unit 40 configured to press the seed film 2 which has been unrolled from the seed film holding unit 20 and has been spread over the soil of the rice paddy, a seed film fixing unit 50 for burying and fixing both sides of the seed film 2 under the soil wherein the seed film 2 has been pressed by the seed film pressing unit 40.

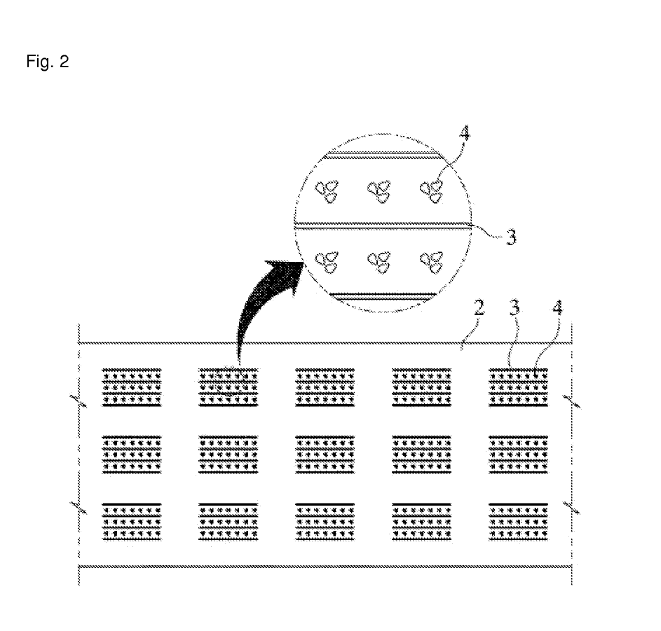

The seed film 2 used in the seed film laying apparatus 100 according to an exemplary embodiment of the present invention is not limited to its specific material or type as far as such a seed film 2 could be biologically degradable. FIG. 2 is a plane view illustrating a seed film 2 according to an exemplary embodiment of the present invention. Referring to FIG. 2, the seed film 2 used according to an exemplary embodiment of the present invention includes a plurality of germination gaps 3 wherein a plurality of rice seeds 4 are adhered to between the germination gaps 3.

The seed film 2 is wound around the roller type seed film holding unit 20. The wound seed film 2 may be rotated and unrolled by a rotation unit configured to rotate the seed film holding unit 20 and may be spread over the soil of the rice paddy. A holding unit support 21 is disposed between the seed film holding unit 20 and the top of the frame for interconnecting the seed film holding unit 20 and the frame.

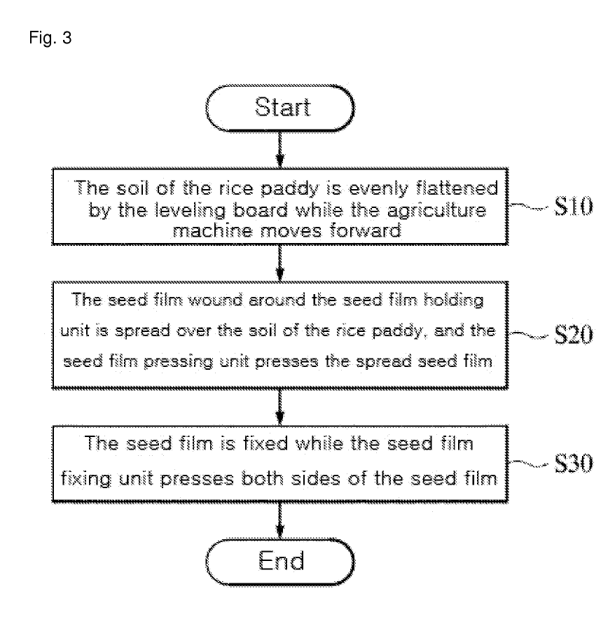

FIG. 3 is a flow chart of a method for laying a seed film according to an exemplary embodiment of the present invention. In the method for laying a seed film according to an exemplary embodiment of the present invention, while the agriculture machine 1 at a rear side of which the seed film laying apparatus 100 is installed moves forwards, the soil of the rice paddy where the seed film 2 has been laid is evenly flattened by the leveling board 30 disposed at the seed film laying apparatus 100 (S10).

In addition, the seed film holding unit 20 rotates by the rotation unit, and the seed film 2 wound around the seed film holding unit 20 is unrolled, and the seed film 2 is spread over the soil of the rice paddy, and the spread seed film 2 is pressed by the seed film pressing unit 40 (S20).

Next, the seed film fixing unit 50 presses the ends of each of both sides of the pressed seed film 2, and the both sides of the seed film 2 are buried under the soil, and the seed film 2 is spread over the soil of the rice field and is fixedly laid (S30). The above-described procedures are automatically and continuously performed while the agriculture machine 1 moves forwards. In addition, when the laying procedure of the seed film 2 is finished, which will be described later, the cutter unit provided at the seed film laying apparatus 100 starts and automatically cuts the seed film 2.

The operation and function of each component of the seed film laying apparatus 100 will be described step by step in detail.

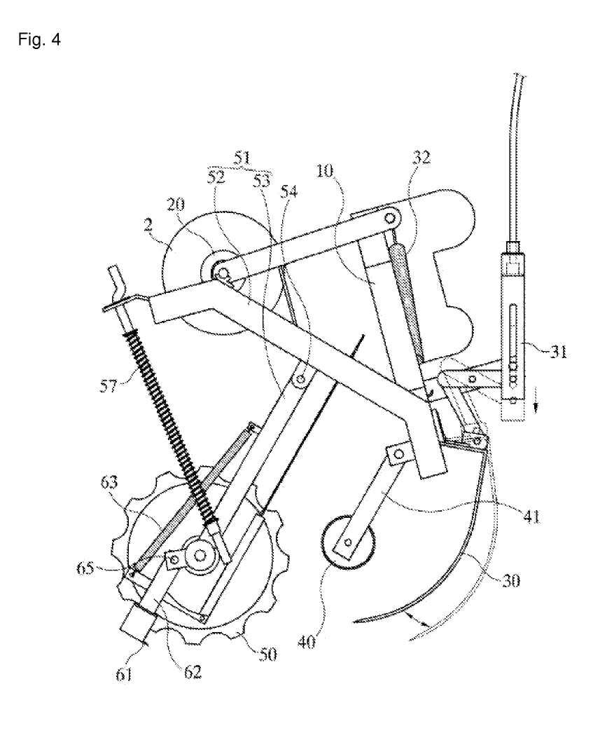

FIG. 4 is a side view illustrating a leveling board 30 and an adjusting unit 31 of the seed film laying apparatus 100 according to an exemplary embodiment of the present invention. As illustrated in FIGS. 1 and 4, a frame 10 may be installed at a rear side of the agriculture machine 1.

As illustrated in FIG. 4, the leveling board 30 is installed at the bottom of the frame 10. It is preferred that the leveling board 30 may be constituted in a shape where it is concavely curved toward the rear side or it has a “L”-shaped or “<”-shaped cross section. Therefore, the soil of the rice paddy where the seed film 2 has been laid may be evenly flattened by the leveling board 30, while the agriculture machine 1 moves forwards. In addition, the longitudinal direction of the leveling board 30 is in parallel with the ground.

As illustrated in FIG. 4, the leveling board 30 according to an exemplary embodiment of the present invention includes an adjusting unit 31 configured to rotate the leveling board 30 about the axis of the longitudinal direction. The above-mentioned adjusting unit 31 is formed of a hydraulic cylinder in the specific exemplary embodiment of the present invention. In the step where the soil of the rice paddy is flattened, the resistance force acting by means of the soil of the rice paddy may differ based on the height or hardness of the soil of the rice paddy, and the sensor measures such resistance force. The controller receives the data measured by the sensor and controls the adjusting unit 31 based on the received data for thereby adjusting the angle of the leveling board 30.

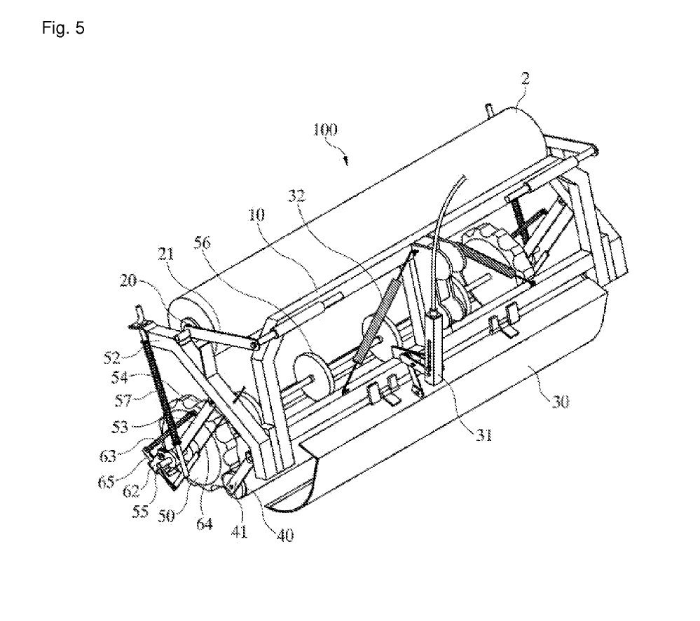

The seed film laying apparatus 100 according to an exemplary embodiment of the present invention further includes an elastic member 32 for balancing the left and right sides of the leveling board 30. FIG. 5 is a perspective view when viewing, from the front side, the seed film laying apparatus 100 according to an exemplary embodiment of the present invention. As illustrated in FIG. 5, the elastic member 32 is disposed between one side of the center of the top of the frame 10 and both sides of the leveling board 30. The left and right balances may be maintained while absorbing the impacts even though there are the changes in the protruded or sloped portions at the soil of the rice paddy and the hardness of the soil of the rice paddy thanks to the provision of the elastic member 32.

In addition, the seed film laying apparatus 100 according to an exemplary embodiment of the present invention, as illustrated in FIGS. 1, 4 and 5, includes a seed film pressing unit 40. Such a seed film pressing unit 40 includes a pressing unit support 41 between the ends of both sides of the seed film pressing unit 40 and the ends of both sides of the bottom of the frame 10, so that the seed film pressing unit 40 may be installed at a predetermined interval from the leveling board 30.

As illustrated in FIGS. 1, 4 and 5, the seed film pressing unit 40 is constituted in a roll shape and may be constituted in such a way that it naturally rotates by pressing force or it rotates by a predetermined rotation unit. The seed film 2 wound around the seed film holding unit 20, therefore, may be unrolled downward by means of the operation of the rotation unit, and the seed film 2 spread over the soil of the rice paddy is pressed by the seed film pressing unit 40. The installation position of the seed film pressing unit 40 is same as the height of the ground of the soil of the rice paddy or is slightly lower than the height of the ground of the soil of the rice paddy, preferably.

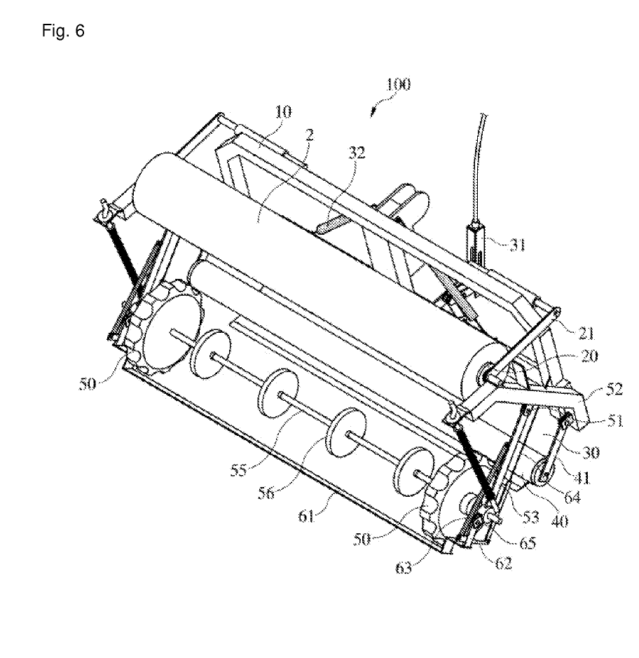

In addition, the seed film laying apparatus 100 according to an exemplary embodiment of the present invention includes a seed film fixing unit 50. FIG. 6 is a perspective view when viewing, from the rear side, the seed film laying apparatus 100 according to an exemplary embodiment of the present invention. The seed film fixing unit 50, as illustrated in FIG. 6, is constituted in such a way that an end portion of one side of the seed film fixing unit 50 is secured by the fixing unit support 51 connected to each of both sides of the bottom of the frame 10. More specifically, an end portion of one side of each of the fixing unit supports 51 is secured to each of both sides of the frame 10, and the wheel-shaped seed film fixing unit 50 is secured to an end portion of the other side of the fixing unit support 51. The seed film fixing unit 50 rotates and digs into the soil of the rice paddy and buries both sides of the seed film 2 for thereby fixing the seed film 2.

Referring to FIG. 6, a plurality of protrusions are formed on an outer circumferential surface of the wheel-shaped seed film fixing unit 50. In addition, the seed film laying apparatus 100 according to an exemplary embodiment of the present invention includes a fixing shaft 55 which connects the centers of the two seed film fixing unit 50. Since the fixing shaft 55 rotates, the seed film fixing unit 50 secured to each of both sides of the fixing shaft 55 can rotate.

The fixing unit support 51, as illustrated in FIG. 6, includes a top support 52 and a bottom support 53. More specifically, the top support 52 is secured to each of both sides of the frame 10, and the bottom support 53 is connected to the intermediate portion of the top support 52. In addition, a first hinge 54 is provided where the top support 52 and the bottom support 53 are engaged, so that the bottom support 53 can rotate about the first hinge 54.

In addition, the seed film laying apparatus 100 according to an exemplary embodiment of the present invention may further include an absorber unit 57 disposed between the end portion of the top of the top support 52 and one side of the bottom support 53. Since the absorber unit 57 is provided, it is possible to adjust the depth where the seed film fixing unit 50 is buried under soil based on the height and hardness of the soil of the rice paddy when fixing both ends of the seed film at the soil of the rice paddy while absorbing and alleviating the impacts generating due to any changes in the height and hardness of the soil of the rice paddy.

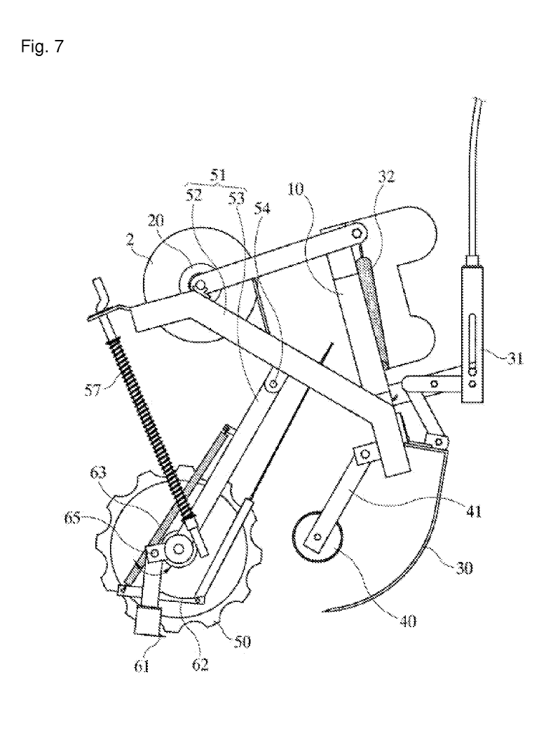

In addition, a cutter unit may be provided at the seed film fixing unit 50 of the seed film laying apparatus 100 according to an exemplary embodiment of the present invention. FIG. 7 is a partial side view illustrating a state where a cutter unit of a seed film fixing unit 50 of the seed film laying apparatus 100 is operated according to an exemplary embodiment of the present invention.

The cutter unit according to an exemplary embodiment of the present invention includes a rotation member 62 of which an intermediate portion is secured through a second hinge 65 to an end portion of the bottom of the bottom support 53, a cutter 61 installed at one side of the rotation member 62, a cutter operation unit 64 secured to one end of the rotation member 62, and a spring member 63 disposed between the other end of the rotation member 62 and the bottom support 53.

Therefore, in a state where the cutter operation unit 64 is not driven (namely, when the laying work of the seed film 2 is going on), the cutter 61 attached to the rotation member 62 has been already moved upward by means of the elastic force of the spring member 63. When it needs to cut the seed film 2 after the laying work of the seed film 2 is finished, the cutter operation unit 64 starts, and the rotation member 62 rotates in the clockwise direction about the direction as illustrated in FIG. 7, and the seed film 2 is cut by the cutter 61 attached to the rotation member 62. The above mentioned cutter operation unit 64 is formed of a hydraulic cylinder according to an exemplary embodiment of the present invention.

In addition, a plurality of pressing wheels 56 may be further provided at the seed film fixing unit 50 of the seed film laying apparatus 100 according to an exemplary embodiment of the present invention. As illustrated in FIG. 6, a plurality of the pressing wheels 56 are provided at the fixing shaft 55 connecting the two seed film fixing units 50. In addition, the diameter of each of the pressing wheels 56 is smaller than the diameter of the seed film fixing unit 50. Therefore, since the seed film fixing unit 50 and the pressing wheels 56 rotate, and the seed film fixing unit 50 digs into the soil of the soil of the rice paddy and fixedly buries both sides of the seed film 2, and at the same time the pressing wheels 56 repress the seed film 2.

<Legend of Reference Numeral>

| | |
|---|---|
| 1: agriculture machine | 2: seed film |
| 3: germination gap | 4: rice |
| 10: frame | 20: seed film holding unit |
| 21: holding unit support | 30: leveling board |
| 31: adjusting unit | 32: elastic member |
| 40: seed film pressing unit | 41: pressing unit support |
| 50: seed film fixing unit | 51: fixing unit support |
| 52: top support | 53: bottom support |
| 54: first hinge | 55: fixing shaft |
| 56: pressing wheel | 57: absorber unit |
| 61: cutter | 62: rotation member |
| 63: spring member | 64: cutter operation unit |
| 62: second hinge | 100: seed film laying apparatus |

We claim:

1. An apparatus for laying a seed film which is installed at a rear side of an agriculture machine such as a ride mulcher, a rice transplanter, a tractor, a cultivator, a farm master, etc., comprising:
a frame which is provided at a rear side of the agriculture machine;
a seed film holding unit around which a seed film is wound and which is installed at the top of the frame;
a leveling board which is provided at the bottom of the frame and the longitudinal direction of which is in parallel with the direction of the plane of the soil of the rice paddy, wherein the leveling board is configured to evenly flatten the soil of the rice paddy where the seed film has been laid;
a seed film pressing unit which is separated by a predetermined distance from the leveling board and is provided at a rear side of the leveling board for thereby pressing the seed film, which has been spread over the soil of the rice paddy, by the rotation of the seed film holding unit; and
a wheel-shaped seed film fixing unit which is provided at a rear side of the seed film pressing unit and is configured to fixedly press the ends of both sides of the pressed seed film,
wherein the leveling board is concavely curved toward the rear side and includes an adjusting means configured to rotate the leveling board about the axis of the longitudinal direction of the leveling board, a sensor configured to detect the height and hardness of the soil of the rice paddy, and a controller configured to control the adjusting means based on the data detected by the sensor.

2. The apparatus of claim 1, further comprising:
an elastic member which is connected to one side of the center of the top of the frame and side surfaces of both sides of the leveling board, respectively, for thereby maintaining left and right balances of the leveling board.

3. The apparatus of claim 1, further comprising:
a holding unit support configured to connect both sides of the top of the frame and ends of both sides of the seed film holding unit, respectively;
a pressing unit support configured to connect both sides of the bottom of the frame and ends of both sides of the seed film pressing unit, respectively; and
a fixing unit support configured to connect both sides of the bottom of the frame and ends of both sides of the seed film fixing unit, respectively.

4. The apparatus of claim 3, further comprising:
a fixing shaft configured to fix the seed film fixing unit provided at each of the ends of the fixing unit support; and
at least one pressing wheel which is disposed at the fixing shaft and is configured to press the seed film and has a diameter smaller than the diameter of the seed film fixing unit.

5. The apparatus of claim 4, wherein the seed film fixing unit further includes an absorber unit configured to adjust the depth where the seed film fixing unit is planted into the soil of the rice paddy and absorb impacts.

6. The apparatus of claim 5, further comprising:
a cutter unit which is provided at an end portion of the fixing unit support for thereby cutting the laid seed film.

7. A method for laying a seed film using the apparatus for laying a seed film of claim 1, comprising:
a step where the soil of a rice paddy is evenly flattened by a leveling board installed at a rear side of an agriculture machine while the agriculture machine moves forward by the operation of the agriculture machine;
a step where a seed film wound around the seed film holding unit by the rotation of the seed film holding unit is laid in front of the seed film pressing unit, and the laid seed film is pressed against the soil of the rice paddy by means of the seed film pressing unit; and
a step where the seed film is fixed on the soil of the rice paddy while the seed film fixing unit presses both sides of the pressed seed film.
